(19) United States
(12) Patent Application Publication
(10) Pub. No.: US 2006/0168521 A1
(43) Pub. Date: Jul. 27, 2006

(54) Edition device and method

(76) Inventors: Fumio Shimizu, Shinagawa-Ku (JP); Nobuo Nakamuara, Tokyo (JP); Hideaki Miyauchi, Tokyo (JP); Takeshi Kawamura, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/560,358

(22) PCT Filed: Jun. 10, 2004
(86) PCT No.: PCT/JP04/08490

§ 371 Date: Dec. 12, 2005

(30) Foreign Application Priority Data
Jun. 13, 2003 (JP) 2003-170124

(51) Int. Cl. G06F 17/00; G06F 15/00

(52) U.S. Cl. 715/530

(57) ABSTRACT

Conventional editing devices cannot obtain an editing result immediately. A process is performed on only necessary parts out of edit material based on a list and only a result of the process of the necessary parts is registered in an external device as an editing result. Therefore, an editing result can be registered in the external device faster than a case of registering an editing result of all ranges based on a list, thus making it possible to realize an editing device and method capable of obtaining an editing result immediately.

### TECHNICAL FIELD

This invention relates to an editing device and method and is suitably applied to an on-air system used in a television broadcasting station, for example.

### BACKGROUND ART

Conventionally, in an on-air system, video/audio obtained by coverage is processed and edited into a desired state with an editing device, and the obtained edited video/audio (hereinafter, referred to as edited video/audio) can be registered in a server as broadcasting clips (video/audio material), so that the clips registered in the server can be read and televised at prescribed timing (for example, Patent reference 1).

Patent Reference 1 Japanese Patent Laid-open No. 10-285533

By the way, a site for creating a news program is required to immediately edit, process, and broadcast video/audio obtained by coverage, and specifically, is required to do very swift action for a break-in bulletin.

However, editing devices used in conventional on-air systems take a lot of time to functionally perform an editing process on video/audio, and specifically, cannot apply special effects to video at a rate faster than real time, which is a problem.

Therefore, it can be considered that, if editing devices used in on-air systems can obtain an editing result faster than ever, waiting time for the editing result can be reduced, so as to sufficiently cope with an emergency such as broadcasting of a break-in bulletin.

### DISCLOSURE OF THE INVENTION

This invention has been made in view of foregoing and proposes to an editing device and method capable of obtaining an editing result immediately.

To solve the above problems, this invention provides an editing device with a control means for controlling a processing means so as to process only necessary parts out of edit material based on a list and for controlling a registration means so as to register only a processing result of the necessary parts in an external device as an editing result.

As a result, this editing device can register the editing result in the external device faster, as compared with a case of registering an editing result of all ranges based on a list.

In addition, this invention provides an editing method with a first step of processing only necessary parts out of edit material based on a list, and a second step of registering only a processing result of the necessary parts in an external device as an editing result.

As a result, this editing method can register the editing result in the external device faster, as compared with a case of registering an editing result of all ranges based on a list.

### BRIEF DESCRIPTION OF THE DRAWINGS

FIG. 1 is a block diagram showing an entire construction of an on-air system according to this embodiment.

FIG. 2 is a block diagram showing a construction of an editing terminal device.

FIG. 3 is a schematic diagram showing a clip explorer window.

FIG. 4 is a schematic diagram showing a VFL creation screen.

FIG. 5 is a schematic diagram showing a VFL creation screen.

FIG. 6 is a schematic diagram showing a VFL creation screen.

FIG. 7 is a schematic diagram showing an FX explorer window.

FIG. 8 is a schematic diagram showing an audio mixing window.

FIG. 9 is a conceptual view explaining a full registration mode and a part registration mode.

FIG. 10 is a conceptual view explaining a playback process of an editing result partly registered.

FIG. 11 is a schematic view explaining the part registration mode.

FIG. 12 is a flowchart showing a first editing result registration procedure.

FIG. 13 is a flowchart showing a second editing result registration procedure.

### BEST MODE FOR CARRYING OUT THE INVENTION

Hereinafter, one embodiment of this invention will be described in detail.

(1) Construction of On-Air System According to this Embodiment

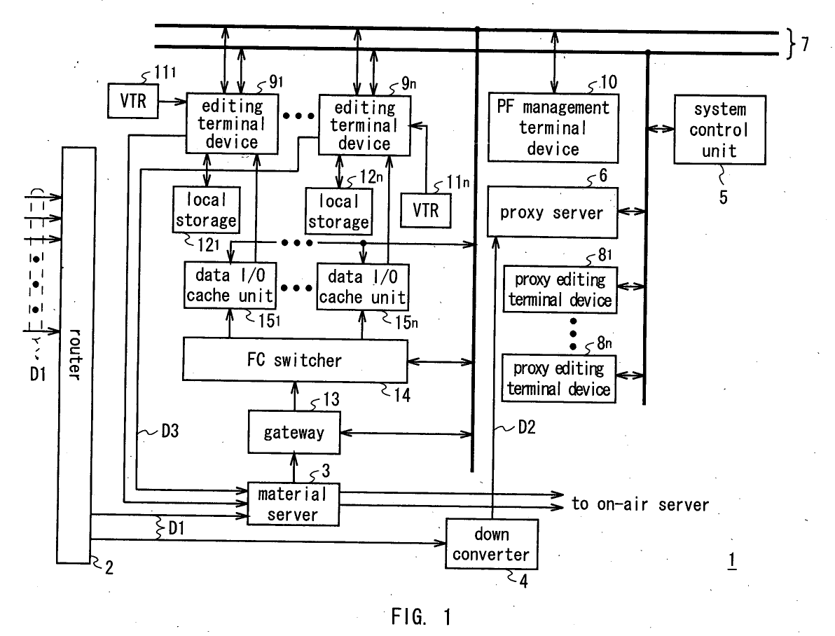

Referring to FIG. 1, reference numeral 1 shows an on-air system according to this invention to be installed in a television broadcasting station or the like. Video/audio data (hereinafter, referred to as high resolution video/audio data) D1 of a resolution of about 140 [Mbps] in an HDCAM format (trademark by Sony Corporation) which is transferred from a coverage site via a satellite communication circuit and so on or is reproduced from a coverage tape with a videotape recorder not shown is input to a material server 3 and a down converter 4 via a router 2.

The material server 3 is an audio video AV server of a large capacity with a recording/playback unit composed of a plurality of RAIDs (redundant arrays of independent disk), and stores a series of high resolution video/audio data D1 given via the router 2 as a file under the control of the system control unit 5.

The down converter 4 converts the received high resolution video/audio data D1 down to data of a resolution of about 8 [Mbps], compresses and encodes the data with the MPEG (Motion Picture Experts Group) format, and sends thus obtained low resolution video/audio data (hereinafter, referred to as low resolution video/audio data) D2 to a proxy server 6.

The proxy server 6 is an AV server having a recording/playback unit composed of a plurality of RAIDs, and stores a series of the low resolution video/audio data D2 given from the down converter 4 as a file under the control of the system control unit 5.

In this way, as to video/audio material (hereinafter, referred to as clip) recorded in the material server 3, the on-air server 1 records low resolution video/audio clips having the same contents, in the proxy server 6.

Then the low resolution video/audio data D2 of each clip stored in the proxy server 6 can be read with each proxy editing terminal device 8₁ to 8ₙ or each editing terminal device 9₁ to 9n being connected to the proxy server 6 via the Ethernet (trademark) 7, so that a list (hereinafter, referred to as VFL (Virtual File List)) specifying which clips out of the clips being stored in the material server 3 should be connected to create processed and edited video/audio (hereinafter, referred to as edited video/audio) can be created with the proxy editing terminal device 8₁ to 8ₙ or the editing terminal device 9₁ to 9ₙ.

In actual, in a VFL creation mode being executed by starting dedicated software, when an operator selects one clip out of the clips being recorded in the proxy server 6 and enters its playback command, the proxy editing terminal device 8₁ to 8n accesses the system control unit 5 via the Ethernet (trademark) 7 and controls the proxy server 6 via the system control unit 5 so as to let the proxy server 6 sequentially read the low resolution video/audio data D2 of the clip.

In addition, the proxy editing terminal device 8₁ to 8ₙ decodes the low resolution video/audio data D2 read from the proxy server 6, and displays video based on the video/audio data of the obtained baseband on a display. Therefore, the operator can create a VFL for only cut editing while visually confirming the video being displayed on the display.

Further, data of thus created VFL (hereinafter, referred to as VFL data) can be transferred to a project file management terminal device 10 via the Ethernet (trademark) 7 from the proxy editing terminal device 8₁ to 8ₙ according to operator's operation. Then the transferred VFL data is stored and managed by the project file management terminal device 10.

Each editing terminal device 9₁ to 9ₙ, on the other hand, is a non-linear editing device with a video board capable of applying video special effects to high resolution video/audio data D1 being recorded in the material server 3 in real time. In the VFL creation mode being executed by starting the dedicated software, the editing terminal device 9₁ to 9ₙ controls the proxy server 6 via the system control unit 5 so as to display the video of a clip specified by the operator at a low resolution, similarly to the proxy editing terminal devices 8₁ to 8ₙ. Therefore, the operator can create a final VFL including setting of special effects and audio mixing while visually confirming the video.

Note that each editing terminal device 9₁ to 9ₙ is connected to a videotape recorder 11₁ to 11ₙ and a local storage 12₁ to 12ₙ such as a hard disk drive, so that video/audio recorded on a video tape can be taken in the local storage 12₁ to 12ₙ via the videotape recorder 11₁ to 11ₙ as a clip and used for editing.

In addition, in creating a VFL, the editing terminal device 9₁ to 9ₙ accesses the system control unit 5 via the Ethernet (trademark) 7 according to operator's operation and controls the material server 3 via the system control unit 5 so as to previously read high resolution video/audio data D1 which may be necessary for creating edited video/audio based on the VFL, from the material server 3.

As a result, the high resolution video/audio data D1 read from the material server 3 is converted into a prescribed format via a gateway 13, and then is given to and stored in the corresponding data I/O cache unit 15₁ to 15ₙ comprising, for example, a semiconductor memory of a storage capacity of about 180 GB via a fiber channel switcher 14.

Then when the operator finishes the creation of the VFL and enters an execution command of the VFL, the editing terminal device 9₁ to 9ₙ sequentially reads the corresponding high resolution video/audio data D1 from the data I/O cache unit 15₁ to 15ₙ based on the VFL, and while applying special effects and audio mixing to the high resolution video/audio data D1 according to necessity, sends data of the obtained edited video/audio (hereinafter, referred to as edited video/audio data) D3 to the material server 3. As a result, the edited video/audio data D3 is stored in the material server 3 as a file under the control of the system control unit 5.

Further, the edited video/audio data D3 being recorded in the material server 3 is transferred to an on-air server, not shown, according to operator's operation, and then read and broadcast from the on-air server according to a play list which is created by a program producer.

As described above, in the on-air system 1, a process from editing to on-air of edited video/audio obtained by the editing can be done efficiently.

(2) Construction of Editing Terminal Device 9₁ to 9ₙ

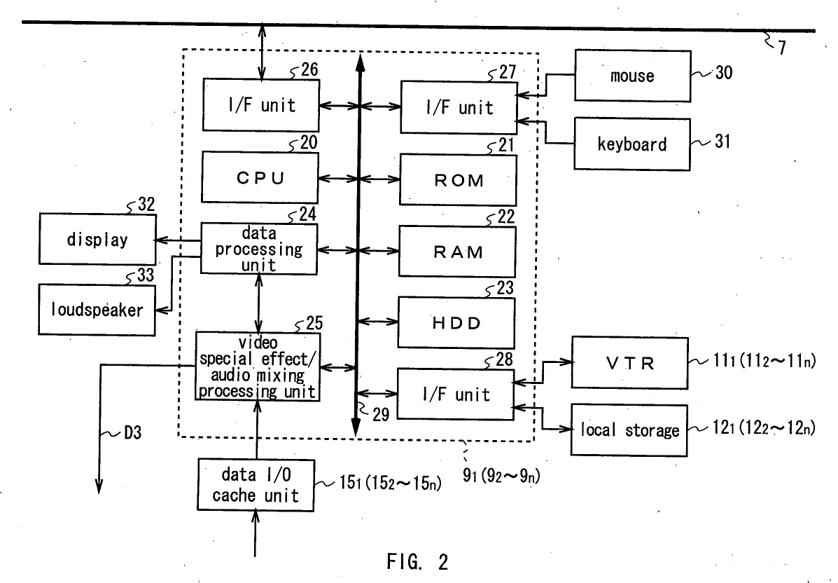

Referring to FIG. 2, each editing terminal device 9₁ to 9ₙ is composed of a CPU (Central Processing Unit) 20, a ROM (Read Only Memory) 21 storing various programs and parameters, a RAM (Random Access Memory) 22 serving as a work memory of the CPU 20, a hard disk drive 23 storing various software, a data processing unit 24 with various video data processing functions and audio data processing functions, a video special effect/audio mixing processing unit 25 for reading specified high resolution video/audio data D1 from a corresponding data I/O cache unit 15₁ to 15ₙ and applying video special effects and audio mixing to the high resolution video/audio data D1 under the control of the CPU 20, and various interface units 26 to 28, which are connected via a CPU bus 29, and is connected to the Ethernet (trademark) 7 via the interface unit 26.

In addition, input devices such as a mouse 30 and a keyboard 31 are connected to the interface unit 27, the interface unit 28 is connected to a videotape recorder 11₁ to 11ₙ and a local storage 12₁ to 12ₙ, and the data processing unit 24 is connected to a display 32 and a loudspeaker 33.

In the VFL creation mode, the CPU 20 reads screen data being stored in the hard disk drive 23 according to necessity and gives this to the data processing unit 24, so as to display various screens, windows, and dialogs as described later, on the display 32.

In addition, in the VFL creation mode, the CPU 20 sends a command to the system control unit 5 (FIG. 1) according to necessity, based on a command entered with the mouse 30 or the keyboard 31, so as to control the material server 3 (FIG. 1), the proxy server 6 (FIG. 1), the FC switcher 14 (FIG. 1) and the data I/O cache unit 15₁ to 15ₙ (FIG. 1) into desired states via the system control unit 5.

Further, the CPU 20 takes in the low resolution video/audio data D2 of a clip which is specified by the operator and is transferred from the proxy server 6 via the Ethernet (trademark) 7, via the interface unit 26, and gives this to the data processing unit 24, so as to display the video based on the low resolution video/audio data D2 at a prescribed position on a screen, window or dialog being displayed on the display 32.

Furthermore, the CPU 20 controls the video special effect/audio mixing processing unit 25, according to necessity, so as to let the video special effect/audio mixing processing unit 25 read corresponding high resolution video/audio data D1 from the data I/O cache unit 15₁ to 15ₙ, apply special effects and audio mixing to the high resolution video/audio data D1 according to necessity, and send thus obtained edited video/audio data D3 to the data processing unit 24, so as to display the video subjected to the special effects based on the edited video/audio data D3 on the display 32, output the audio subjected to the audio mixing from the loudspeaker 33, and send the edited video/audio data D3 to the material server 3 according to necessity.

(3) VFL Creation Procedure in Editing Terminal Device 9₁ to 9ₙ

A VFL creation procedure with the editing terminal device 9₁ to 9ₙ will be now described.

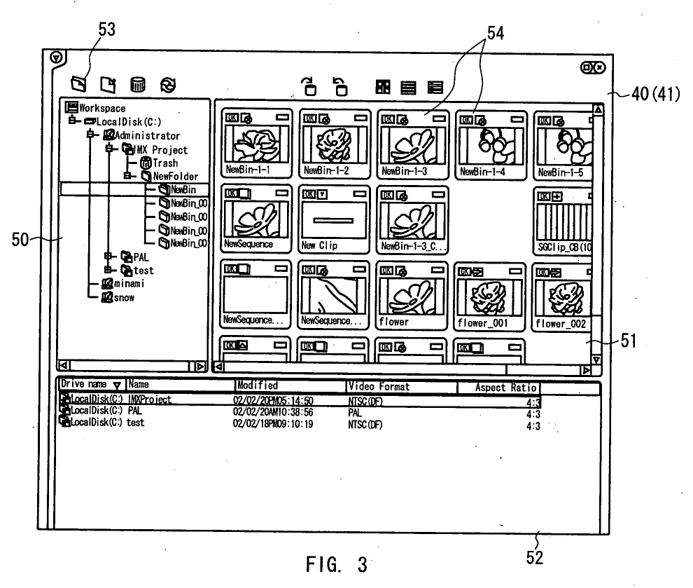

In the VFL creation mode, the CPU 20 of the editing terminal device 9₁ to 9ₙ displays a clip explorer (Clip Explorer) window 40 as shown in FIG. 3 and a server site explorer (Server Site Explorer) window 41 having the same structure on the display 32 (FIG. 2) according to operator's operation.

In this case, the clip explorer window 40 is a window to display a list of clips being stored in the local storage 12₁ to 12ₙ and the data I/O cache unit 15₁ to 15ₙ being connected to the editing terminal device 9₁ to 9ₙ, and is composed of a tree display part 50, a clip display part 51, and a clip list display part 52.

The tree display part 50 of the clip explorer window 40 shows location information of clips in a tree view on the basis of management information of the clips being stored in the data I/O cache units 15₁ to 15ₙ being managed by the system control unit 5 (FIG. 1) and management information of the clips being stored in the local storage 12₁ to 12ₙ being managed by the own device, the location information indicating which drive, holder, file, or bin the clips are stored in.

In addition, the clip display unit 51 of the clip explorer window 40 displays a list of the thumbnail images of the beginning frames and the clip names of all clips being stored in a bin being selected in the tree display part 50, in a form of icons. The clip list display part 52 displays a list of management information for the clips being displayed in the clip display part 51, such as the name of a drive storing a clip, a clip name, a recording date, a video format and a material length. In the following description, an icon corresponding to each clip being displayed in the clip display part 51 is referred to as a clip icon 54.

The server site explorer window 41 is a window to display a list of clips being recorded in the material server 3 and the proxy server 6, and is composed of a tree display part 50, a clip display part 51, and a clip list display part 52, similarly to the server site explorer window 41.

The tree display part 50 of the server site explorer window 41 displays location information of the clips being recorded in the material server 3 and the proxy server 6 based on management information of the clips being managed by the system control unit 5 (FIG. 1) in a tree view. The clip display part 51 and the clip list display part 52 display the same contents as the clip display part 51 and the clip list display part 52 of the clip explorer window 40, with regard to the clips.

When the operator creates a new VFL, he/she clicks a new sequence creation button 53 out of a plurality of buttons being displayed at an upper part of the clip explorer window 40. As a result, a clip (hereinafter, referred to as sequence clip) for the VFL to be created is created by the CPU 20 and a clip icon 54 for the sequence clip is displayed in the clip display part 51 of the clip explorer window 40.

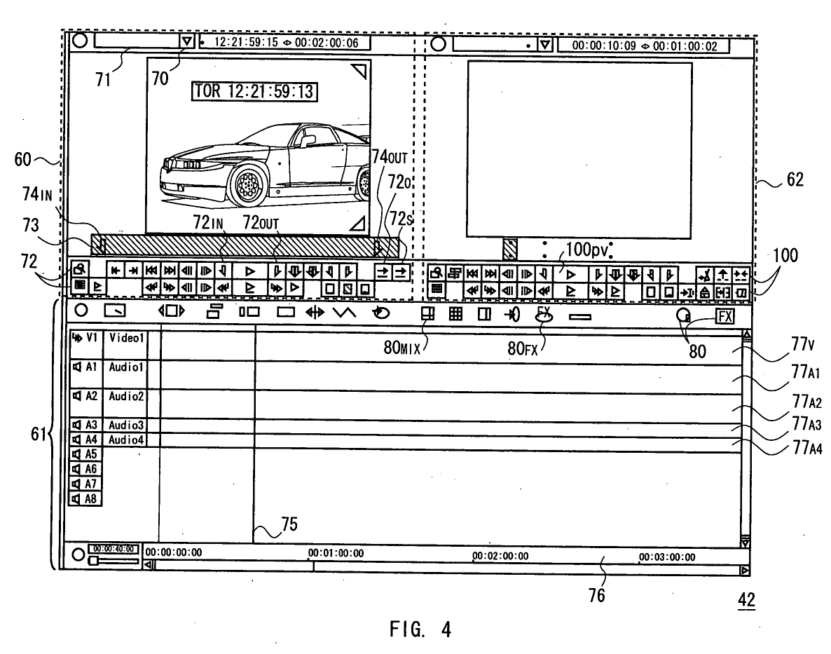

In addition, a new VFL creation screen 42 as shown in FIG. 4 is displayed on the display 32. This VFL creation screen 42 is composed of a source viewer part 60 for extracting a desired part as a cut while visually confirming the video of a clip, a time line part 61 for setting edit details indicating how cuts extracted are arranged and which special effects are applied to the connecting parts of the cuts, and a master viewer part 62 for confirming the edit details set in the time line part 61 with actual video.

Then by moving the clip icon 54 of a desired clip out of the clip icons of the clips being displayed in the clip display part 51 of the server site explorer window 41 into the source viewer part 60 of the VFL creation screen 42 by drug and drop, the operator can select the clip as a clip to be used for editing, and can select a plurality of clips as clips to be used for the editing by repeating the above operation.

In addition, by clicking a clip selection menu display button 70 being displayed at an upper side of the source viewer part 60 of the VFL creation screen 42, the operator can display a list of the clips selected as described above. Further, by clicking a desired clip out of this menu, the operator can select it as a target of the editing. Note that the name of the clip selected at this time is displayed in a clip list box 71 and the video of, for example, the beginning frame of the clip is displayed in the source viewer part 60.

Then in the VFL creation screen 42, the video based on low resolution video/audio data D2, which has been recorded in the proxy server 6 (FIG. 1), of the clip of which the video is displayed in the source viewer part 60 is reproduced at a normal speed, frame by frame, or backwards frame by frame, by clicking a corresponding command button 72 out of a plurality of various command buttons being displayed on a lower side of the source viewer part 60.

In actual, when a command button 72 for the normal playback, frame-by-frame playback, or frame-by-frame backward playback is clicked out of the plurality of command buttons 72, the CPU 20. controls the proxy server 6 via the system control unit 5 so as to let the proxy server 6 output the low resolution video/audio data D2 of the video/audio part corresponding to the clip. As a result, the normal playback video, frame-by-frame playback video, or frame-by-frame backward playback video of a low resolution based on the low resolution video/audio data D2 is displayed in the source viewer part 60.

Thus the operator can specify a start point (IN-point) and an end point (OUT-point) of a video/audio part to be used as a cut, out of the video/audio of the clip by clicking a mark-in button 72_{IN} and a mark-out button 72_{OUT} of the command buttons 72 while visually confirming the video being displayed in the source viewer part 60.

In addition, When an IN-point or an OUT-point is specified as described above, a mark (hereinafter, referred to IN-point mark) 74_{IN} representing the IN-point position or a mark (hereinafter, referred to as OUT-point mark) 74_{OUT} representing the OUT-point position is displayed at a position (that is, a position corresponding to the IN-point or the OUT-point, considering that the length of the position bar 73 is the material length of the clip) corresponding to the IN-point or the OUT-point of the position bar 73 being displayed on a lower side of the video of the source viewer part 60.

On the other hand, the operator can create a VFL by using video/audio parts to be used as cuts of clips specified as described above, with the following procedure.

That is, after determining a range of a video/audio part to be used as a cut out of a clip as described above, move a play line 75 being displayed in the time line part 61 to a desired position with a mouse with a time scale 76 being displayed at a lower part of the time line part 61 as an index, and then clock an overwrite button 72_{O} or a splice-in button 72_{S} out of the various command buttons 72 being displayed at a lower part of the source viewer part 60.

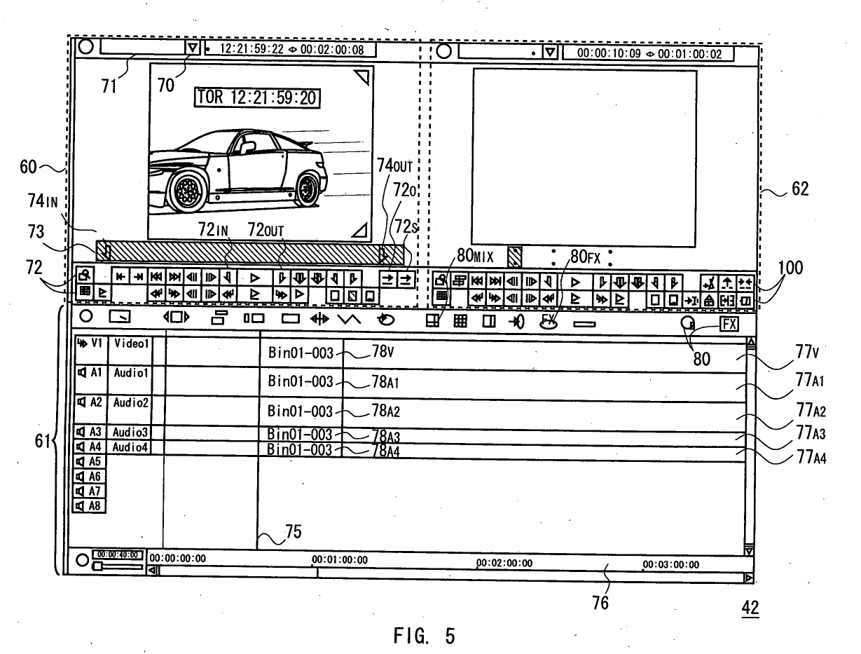

As a result, as shown in FIG. 5, by overwrite by clicking the overwrite button 72_{O} or by inserting by clicking the splice-in button 72_{S}, a colored area 78_{V} of a length corresponding to the material length of the video/audio part is displayed on a video track 77_{V} of the time line part 61 with its beginning located at the play line 75.

When audio is attached to the video/audio part, colored areas 78_{A1} to 78_{A4} having the same length as the corresponding colored area 78_{V} of the video track 77_{V} are displayed on audio tracks 77_{A1} to 77_{A4} equal to the number of channels out of a plurality of audio tracks 77_{A1} to 77_{A4} being provided under the video tack 77_{V} with their beginnings located at the play line 75.

In this connection, at this time, the CPU 20 notifies the system control unit 5 of a command according to operator's operation. As a result, under the control of the system control unit 5, the high resolution video/audio data D1 of the video/audio part of the corresponding clip is read from the material server 3 (FIG. 1) with a margin of several seconds on the IN-point side and the OUT-point side, and is given to and stored in the data I/O cache unit 15₁ to 15ₙ of the editing terminal device 9₁ to 9ₙ via the gateway 13 (FIG. 1) and the FC switcher 14 (FIG. 1).

Further, to output audio other than the audio attached to the video of the video/audio part at a time of reproducing the edited video/audio, click the clip select memu display button 70, select the audio being registered, out of a list of clips being displayed, move the play line 75 of the time line part 61 to a desired position, and after specifying a desired audio tack 77_{A1} to 77_{A4}, click the above-described overwrite button 72_{O} or the splice-in button 72_{S}.

In this case, a colored area 78_{A1} to 78_{A4} of a length corresponding to the material length of the clip is displayed on an audio track 77_{A1} to 77_{A4} specified, with its beginning located at the play line 75. In a case where this clip is recorded in the material server 3, the audio data is read from the material server 3 and stored in the data I/O cache unit 15₁ to 15ₙ.

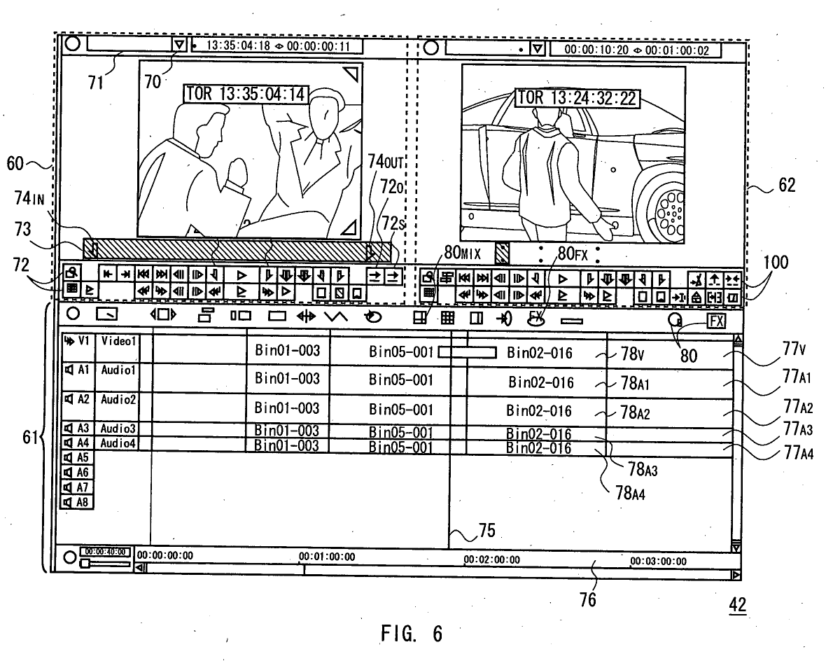

Then for desired clips, the operator repeats operation including selection (extraction of cut) of video/audio parts and paste of the video/audio parts to the time line part 61 (display of colored areas 78_{V}, 78_{A1} to 78_{A4} in the video track 77_{V} and corresponding audio tracks 77_{A1} to 77_{A4}), thereby sequentially displaying the colored areas 78_{V}, 78_{A1} to 78_{A4} on the video track 77_{V} and the audio tracks 77_{A1} to 77_{A4} so as to continue on the time scale 76 for a desired period from start (“00:00.00:00”) of the time scale 76 as shown in FIG. 6.

Displaying colored areas 78_{V}, 78_{A1} to 78_{A4} on the video track 77_{V} and the audio tracks 77_{A1} to 77_{A4} of the time line part 61 means that the video/audio of a corresponding part of a cut corresponding to the colored areas 78_{V}, 78_{A1} to 78_{A4} is displayed and output at a time indicated by the time scale 76 in reproducing the edited video/audio. Therefore, a VFL specifying an order and contents of video/audio to be displayed or output as edited video/audio can be created through the above operation.

In this connection, the number of video tracks 77_{V} and the number of audio tracks 77_{A1} to 77_{A4} to be displayed in the time line part 61 are set as desired. In a situation where a plurality of video tracks 77_{V} and a plurality of audio tracks 77_{A1} to 77_{A4} are displayed, when cuts and clips are pasted onto the video tracks 77_{V} and audio tracks 77_{A1} to 77_{A4}, video obtained by superimposing videos of the video tracks 77_{V} at the same position on the time scale 76 is obtained as edited video and audio obtained by composing audio of the audio tracks 77_{A1} to 77_{A4} at the same position on the time scale 76 is obtained as edited audio.

In creating a VFL as described above, when a special effect is desired to be applied to a switching part of the first cut to the next second cut, the desired special effect can be set with the following procedure.

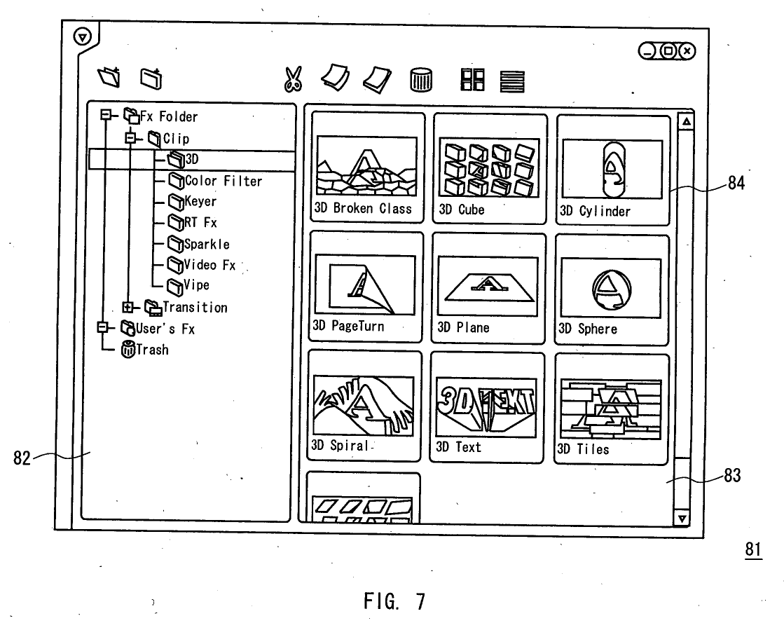

First, paste a first cut and a following second cut onto the video track 77_{V} so as to continue on the position bar 73, and then click an FX explorer button 80FX out of the various buttons 80 being displayed at an upper part of the time line part 61. Thereby, as shown in FIG. 7, a window (hereinafter, referred to as FX explorer window) 81 displaying various special effects which can be applied by the editing terminal device 9₁ to 9ₙ in a tree view in a tree display part 82 and the details of the special effects in an icon display part 83 with icons can be displayed.

Then, out of the icons (hereinafter, referred to as special effect icons) 84 being displayed in the icon display part 83 of the FX explorer window 81, paste the special effect icon 84 of a desired video special effect onto the switching part of the first and second cuts on the video track 77_{V} of the VFL creation screen 42 by drug and drop.

Therefore, when edited video is created, the video special effect corresponding to the special effect icon pasted as described above is applied at a time of switching the first cut video to the second cut video.

In addition, in creating a VFL, when audio mixing is desired to be applied to the audio of a cut or a clip pasted on an audio tack 77_{A1} to 77_{A4}, the audio mixing can be set with the following procedure.

First, move the play line 75 being displayed in the time line part 61 of the VFL creation screen 42 onto the colored area 78_{A1} to 78_{A4} corresponding to the cut or the clip which is desired to be subjected to the audio mixing, out of the cuts and clips pasted onto the audio tracks 77_{A1} to 77_{A4}, and click an audio mixer button 80_{MIX} out of a plurality of buttons being displayed at an upper part of the time line part 61.

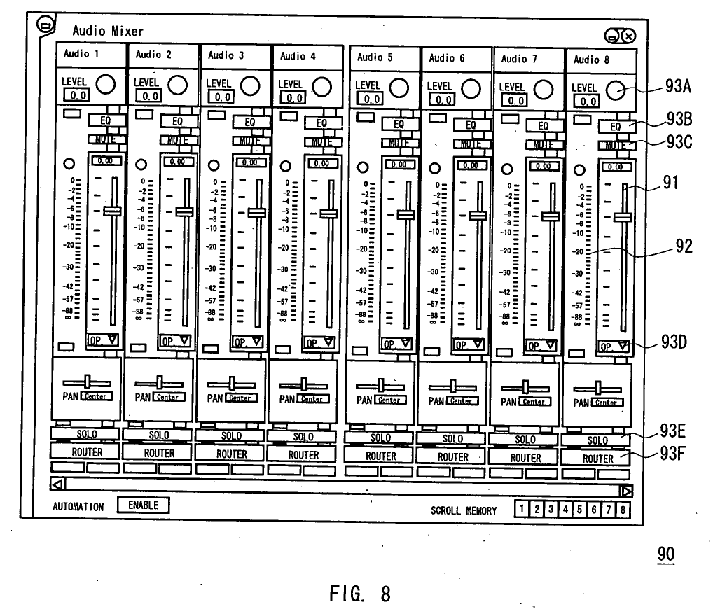

Thereby, as shown in FIG. 8, an audio mixer window 90 with a volume 91, a level meter 92 and various setting buttons 93A to 93F provided corresponding to each audio track 77A1 to 77A4 of the time line part 61 of the VFL creation screen 42 is displayed.

And then operate the volume 91 and the setting buttons 93A to 93F corresponding to a desired audio track 7A1 to 77A4 of the time line part 61 of the VFL creation screen 42, which are displayed in the audio mixer window 90, while visually confirming the level meter 92.

Therefore, when edited audio is output, the audio mixing is applied to the audio data of the cut or clip with the details set as described above in reproducing the cut or clip pasted onto the audio track 77_{A1} to 77_{A4}.

Further, with the VFL creation screen 42, by moving the play line 75 of the time line part 61 to a desired position with a mouse and clicking a preview button 100_{PV} out of a plurality of command buttons 100 being displayed at a lower part of the master viewer part 62 after or while creating a VFL as described above, high resolution edited video can be reproduced in the master viewer part 62 at a normal speed with the video/audio part corresponding to the position of the play line 75 as a start point.

In actual, when the preview button 100_{PV} is clicked, the CPU 20 controls the video special effect/audio mixing processing unit 25 (FIG. 2) so as to let this unit 25 read the high resolution video/audio data D1 of the corresponding video/audio part being stored in the data I/O cache unit 15₁ to 15ₙ and apply video special effects and audio mixing to the high resolution video/audio data D1 according to necessity.

As a result, the high resolution edited video/audio data subjected to the video special effects and the audio mixing is created and given to the data processing unit 24, so as to display the edited video based on the edited video/audio data in the master viewer part 62 of the VFL creation screen 42 and output the edited audio from the loudspeaker 33.

Therefore, the operator can create a VFL or confirm the details of a created VFL while visually confirming (previewing) the edit details based on the edited video being displayed in the master viewer part 62 of the VFL creation screen 42.

After creating a VFL as described above, by moving the clip icon 54 of the sequence clip of this VFL being displayed in the clip display part 51 of the clip explorer window 40 (FIG. 3) into the clip display part 51 of the server site explorer window 41 (FIG. 3) by drug and drop, the editing result based on the VFL can be registered in the material server 3 (FIG. 1).

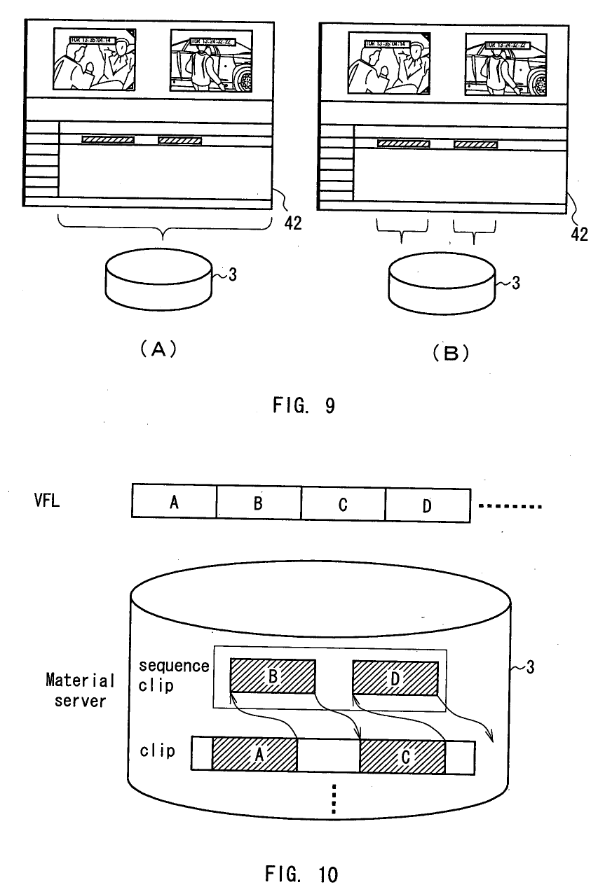

At this time, as a registration mode for registering the editing result based on the VFL in the material server 3, the operator can select and set one of a full registration mode to register the edited video/audio data D3 of all ranges of the edited video/audio based on the VFL in the material server 3 as shown in FIG. 9(A) and a batch part registration mode to collectively register only the edited video/audio data D3 of the video/audio parts (that is, video/audio parts which have not been recorded in the material server 3 out of the edited video/audio) subjected to the video special effects or the audio mixing out of the edited video/audio. And a dialog (hereinafter, referred to as registration mode setting dialog) for this is displayed when the clip icon 54 of the sequence clip of the VFL is moved into the clip display part 51 of the server site explorer window 41 by drug and drop.

When the full registration mode is selected as a registration mode, the edited video/audio data D3 is created for all ranges of the edited video/audio specified by the VFL created this time, and is given to the material server 3 to be stored in a file of the above-described sequence clip. In addition, the data (hereinafter, referred to as VFL data) of the VFL is given to the project file management terminal device 10 (FIG. 1) via the Ethernet (trademark) 7 and then this VFL data is stored and managed by the project file management terminal device 10.

When the batch part registration mode is selected as a registration mode, on the contrary, the edited video/audio data D3 for only each video/audio part (that is, each video/audio part from start of video special effects or audio mixing until end) to be subjected to the video special effects or the audio mixing, out of the edited video/audio based on the VFL created this time, is created and is given to the material server 3 to be stored in the file of the above-described sequence clip. In addition, the VFL data is given to the project file management terminal device 10 via the Ethernet (trademark) and then this VFL data is stored and managed by this project file management terminal device 10.

Note that, in a case where an editing result is partly registered, the parts (parts A and C indicated by oblique lines in FIG. 10) selected as edited video/audio out of the clips being recorded in the material server 3 and the parts (parts B and D indicated by oblique lines in FIG. 10) subjected to the video special effects or the audio mixing being registered in the material server 3 as sequence clips are read based on the VFL from the material server 3 in order at a time of reproducing the editing result, as shown in FIG. 10.

As the part registration mode to partly register an editing result based on a created VFL in the material server 3, on the other hand, this editing terminal device 9₁ to 9ₙ is provided with a sequential part registration mode to sequentially register, in the material server 3, only the edited video/audio data D3 of each video/audio part to be subjected to video special effects or audio mixing at a stage of creating the VFL, in addition to a batch part registration mode to collectively register, in the material server 3, only the edited video/audio data D3 of each video/audio part to be subjected to video special effects or audio mixing as described above after creating the VFL.

When the sequential part registration mode is set as an initial setting, every time when a video/audio part which should be subjected to video special effects or audio mixing is reproduced at a normal speed by clicking the preview button 100_{PV} of the master viewer part 62 (FIG. 4) on the VFL creation screen 42 (FIG. 4) during creating a VFL, the editing terminal device 91 to 9, transfers the edited video/audio data D3 of the video/audio part subjected to the video special effects or the audio mixing, to the material server 3. Then this partly edited video/audio data D3 is stored in the file of a sequence clip created in the material server 3 in correspondence with the VFL.

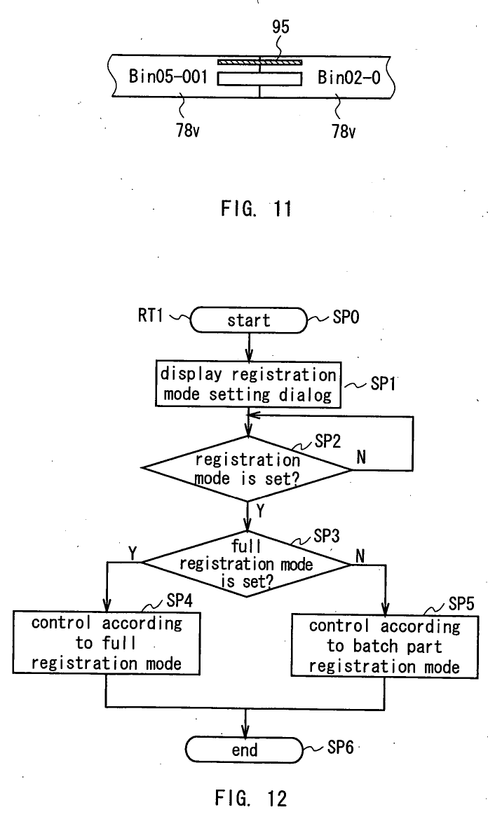

In addition, when the partly edited video/audio data D3 is registered in the material server 3 as described above, a red line 95 as shown in FIG. 11 is displayed on the video/audio part to which the video special effects should be applied or on the video/audio part to which audio mixing should be applied, in the time line part 61 of the VFL creation screen 42.

Then when the creation of the VFL is completed and the clip icon 54 (FIG. 3) of the sequence clip of the VFL is moved into the clip display part 51 (FIG. 3) of the server site explorer window 41 (FIG. 3) by drug and drop, the edited video/audio data D3 for each video/audio part of, which the edited video/audio data D3 has not been registered in the material server 3, out of the video/audio parts which should be subjected to video special effects or audio mixing out of the edited video/audio based on the VFL, is created and collectively transferred to the material server 3. Then this partly edited video/audio data D3 is stored in the file of a sequence clip provided in the material server 3 in correspondence with the VFL as described above.

In addition, this VFL data is given to the project file management terminal device 10 (FIG. 1) via the Ethernet (trademark) 7 (FIG. 1) and then is stored and managed by the project file management terminal device 10.

As described above, this editing terminal device 9₁ to 9ₙ is capable of registering an editing result in the material server 3 much faster than a case of registering the edited video/audio data D3 of all ranges based on a created VFL in the material server 3.

(4) Editing Result Registration Procedure

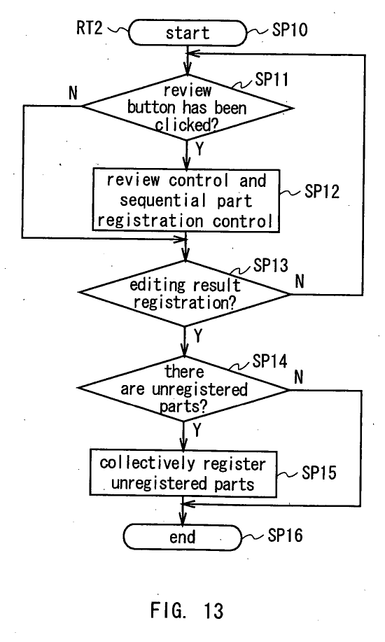

An editing result based on a VFL created as described above is registered in the material server 3 under the control of the CPU 20 (FIG. 2) of the editing terminal device 9₁ to 9ₙ with a first editing result registration procedure RT1 shown in FIG. 12 or a second editing result registration procedure RT2 shown in FIG. 13.

In actual, when an operator moves the clip icon 54 (FIG. 3) of the sequence clip of a VFL into the clip display part 51 (FIG. 3) of the server site explorer window 41 (FIG. 3) by drag and drop in a situation where the sequential part registration mode is not set, the CPU 20 starts the first editing result registration procedure RT1 shown in FIG. 12 from step SP0 and displays the above-described registration mode setting dialog at next step SP1.

Then the CPU 20 moves to step SP2 to wait until one of the full registration mode and the part registration mode is selected as a registration mode on the registration mode dialog.

When the operator selects one of the full registration mode and the part registration mode as a registration mode, the CPU 20 moves to step SP3 to determine whether the selected-mode is the full registration mode.

When an affirmative result is obtained at step SP3, the CPU 20 moves to step SP4 to control the video special effect/audio mixing processing unit 25 (FIG. 2) based on a VFL created this time so as to sequentially read the high resolution video/audio data D1 required for creation of edited video/audio for all ranges of the edit details specified by the VFL, from the corresponding data I/O cache unit 15₁ to 15ₙ and then apply special effects and audio mixing process, according to necessity, to the high resolution video/audio data D1 based on the VFL.

As a result, the edited video/audio data D3 of all ranges based on the VFL is created in the video special effect/audio mixing processing unit 25 and is stored in the file of the sequence clip moved in the material server 3 in correspondence with the VFL.

In addition, the CPU 20 sends data of this VFL (hereinafter, referred to as VFL data, simply) to the project file management terminal device 10 via the Ethernet (trademark) 7 and moves to step SP6 to finish this first edited video/audio processing procedure RT1.

When a negative result is obtained at step SP3, on the contrary, the CPU 2 moves to step SP5 to search the contents of the VFL created this time to find video/audio parts to which video special effects or audio mixing should be applied, and controls the video special effect/audio mixing processing unit 25 based on the searching result and the VFL.

As a result, out of the edited video/audio based on this VFL, only the high resolution video/audio data D1 for each video/audio part to which the video special effects or the audio mixing should be applied is read from the data I/O cache unit 15₁ to 15ₙ, this high resolution video/audio data D1 is subjected to the video special effects or the audio mixing based on the VFL in the video special effect/audio mixing processing unit 15, and thus obtained partly edited video/audio data D3 is stored in the file of the sequence clip moved in the material server 3 in correspondence with the VFL.

In addition, the CPU 20 sends the VFL data to the project file management terminal device 10 via the Ethernet (trademark) 7 and then moves to step SP6P to finish this first edited video/audio processing procedure RT1.

In a case where the sequential part registration mode is initially set, on the other hand, when the new sequence creation button 53 (FIG. 3) of the clip explorer window 40 (FIG. 3)-is clicked, the CPU 20 starts the second edited video/audio processing procedure RT2 shown in FIG. 13 as well as displaying a new VFL creation screen 42 (FIG. 4) on the display 32 (FIG. 2), and at next step SP11, determines whether the preview command button 100_{PV} of the master viewer part 62 (FIG. 4) on the VFL creation screen 42 has been clicked.

When a negative result is obtained at step SP1, the CPU 20 moves to step SP13 to determine whether the clip icon 54 (FIG. 3) of the sequence clip corresponding to the VFL being displayed in the clip display part 51 (FIG. 3) of the clip explorer window 40 (FIG. 3) has been moved into the clip display part 51 of the server explorer window 41 (FIG. 3) by drag and drop.

When a negative result is obtained at step SP13, the CPU 20 returns back to step SP11 and repeats a loop of steps SP11-SP13-SP11 until an affirmative result is obtained at step SP11 or step SP13.

Then when the operator clicks the preview command button 100_{PV} of the master viewer part 62 on the VFL creation screen 42 with the mouse and an affirmative result is obtained at step SP11, the CPU 20 moves to step SP12 from step SP11 to control the video special effect/audio mixing processing unit 25 based on the details of the VFL being created.

As a result, necessary high resolution video/audio data D1 is read by the video special effect/audio mixing processing unit 25 from the data I/O cache unit 15₁ to 15ₙ, and this high resolution video/audio data D1 is subjected to video special effects or audio mixing, according to necessity, in the video special effect/audio mixing processing unit 2. Then the high resolution video based on thus obtained edited video/audio data D3 is displayed in the master viewer part 62 (FIG. 4) of the VFL creation screen 42.

In addition, the CPU 20 sequentially determines whether edited video/audio being reproduced is a video/audio part which should be subjected to video special effects or audio mixing. When an affirmative result is obtained, the CPU 20 controls the video special effect/audio mixing processing unit 24 to send the edited video/audio data D3 created by the video special effect/audio mixing processing unit 25, to the material server 3. Thus the edited video/audio data D3 of the video/audio part which should be subjected to the video special effects or the audio mixing is stored in the file of a sequence clip provided in the material server 3 in correspondence with the VFL.

When the operator enters a preview stop command with the mouse, the CPU 20 moves to step SP13 and repeats steps SP11 to SP13 as described above, thereby storing the edited video/audio data D3 of a video/audio part previewed out of the video/audio parts which should be subjected to video special effects or audio mixing specified by the VFL being created, in the file of a sequence clip provided in the material server 3.

When an affirmative result is obtained at step SP13, the CPU 20 moves to step SP14 to determine whether there is a video/audio part of which the edited video/audio data D3 has not been registered in the material server 3, out of the video/audio parts which should be subjected to the video special effects or the audio mixing out of the edited video/audio based on the VFL created this time.

When an affirmative result is obtained at step SP14, the CPU 20 moves to step SP15 to control the video special effect/audio mixing processing unit 25 so as to let this unit 25 sequentially read the high resolution video/audio data D1 of each video/audio part which should be subjected to the video special effects or the audio mixing and of which the edited video/audio data D3 has not been registered in the material server 3, apply the video special effects or the audio mixing to the high resolution video/audio data D1, and sequentially send thus obtained edited video/audio data D3 to the material server 3. As a result, the edited video/audio data D3 is stored in the file of a sequence clip provided in the material server 3 in correspondence with the VFL.

In addition, the CPU 20 sends this VFL data to the project file management terminal device 10 via the Ethernet (trademark) 7, and moves to step SP16 to finish this second editing result registration procedure RT2.

As described above, the CPU 20 register the editing result based on the created VFL in the material server 3 in a registration mode set by the operator.

(5) Operation and Effects of the Embodiment

According to the above configuration, the editing terminal device 9₁ to 9ₙ of this on-air system 1 registers only the edited video/audio data D3 of video/audio parts which should be subjected to video special effects or audio mixing, out of the edited video/audio data D3 obtained by editing based on a created VFL, in the material server 3 as an editing result in the full registration mode or in the sequential part registration mode.

Then in reproducing the editing result, parts which have been selected as edited video/audio out of clips being recorded in the material server 3 and parts which have been subjected to the video special effects or the audio mixing and have been registered in the material server 3 as an editing result are read from the material server in order based on the VFL, thereby obtaining the edited video/audio of all ranges based on the VFL.

Therefore, this on-air system 1 can register an editing result based on the VFL in the material server 3 faster than a case of registering the edited video/audio data D3 of all ranges of the edited video/audio obtained based on the VFL while creating the data D3, thereby being capable of reducing user's waiting time.

According to the above configuration, out of the edited video/audio data D3 obtained by editing based on a created VFL, only the edited video/audio data D3 of video/audio parts which should be subjected to video special effects or audio mixing is registered in the material server 3 as an editing result, which enables much faster registration of the editing result based on the VFL in the material server 3, thus making it possible to realize an on-air system capable of obtaining an editing result immediately.

(6) Other Embodiments

Note that the above embodiment has described a case of applying this invention to the editing terminal devices 9₁ to 9ₙ of the on-air system 1. This invention, however, is not limited to this and can be widely applied to other various editing devices such as editing devices for systems other than on-air systems and editing devices which operate alone.

Further, the above embodiment has described a case of applying a range after video special effects or audio mixing actually starts until they end as a range of each video/audio part which should be subjected to the video special effects or the audio mixing and is registered in the material server 3 in the batch part registration mode and in the sequential part registration mode. This invention, however, is not limited to this and a range with margins on both ends of a video/audio part after the video special effects or the audio mixing actually starts until they end can be applied.

Furthermore, the above embodiment has described a case of registering an editing result in the material server 3 which is an external device of the editing terminal devices 9₁ to 9ₙ and registering a VFL in the project file management terminal device 10 which is an external device of the editing terminal devices 9₁ to 9ₙ. This invention, however, is not limited to this and the VFL and the editing result based on this can be registered in the material server 3 as one sequence clip.

Furthermore, the above embodiment has described a case where edit material is video/audio data. This invention, however, is not limited to this and can be widely applied to a case where the edit material is analog or digital video information and analog or digital video information.

Furthermore, the above embodiment has described a case where the video special effect/audio mixing processing unit 25 as a processing means for applying a prescribed process to edit material has a function to apply video special effects and audio mixing to high resolution video/audio data D1. This invention, however, is not limited to this and the processing means can be designed to be capable of performing processes other than the video special effects and the audio mixing depending on kinds of edit material.

Furthermore, the above embodiment has described a case where the video special effect/audio mixing processing unit 25 has a function as a processing means for applying a prescribed process to edit material and a function as a registration means for registering an editing result in an external device. This invention, however, is not limited to this and a circuit block with a function serving as the registration function can be provided separately from the video special effect/audio mixing processing unit 25.

Furthermore, according to the above embodiment, when the clip icon 54 of the sequence clip of a VFL being displayed in the clip display part 51 of the clip explorer window 40 is moved into the clip display part 51 of the server site explorer window 41 by drag and drop after finishing the creation of the VFL in the sequential part registration mode, the CPU 20 serving as a control means for controlling the video special effect/audio mixing processing unit 25 serving as a processing means and a registration means collectively registers video/audio parts of which the edited video/audio data D3 have not been registered in the material server 3, out of the video/audio parts obtained by video special effects or audio mixing, in the material server 3. However, as a trigger for collectively registering remaining video/audio parts in the material server 3, other triggers can be applied, for example, a special button is additionally provided and the registration may be made when the button is clicked.

As described above, according to this invention, an editing device is provided with a control means for controlling a processing means for performing a processing process on only necessary parts out of edit material based on a list and controlling a registration means so as to register only a result of the processing process of the necessary parts in an external device as an editing result. Therefore, the editing result can be registered in the external device faster than a case of registering an editing result of all ranges based on the list, thus making it possible to realize an editing device capable of obtaining an editing result immediately.

Furthermore, according to this invention, an editing method is provided with a fist step of applying a process to necessary parts out of edit material based on a list and a second step of registering only a result of the process of the necessary parts in an external device as an editing result, thereby the editing result can be registered in the external device faster than a case of registering an editing result of all ranges based on a list, thus making it possible to realize an editing method capable of obtaining an editing result immediately.

### INDUSTRIAL APPLICABILITY

This invention can be widely applied to editing systems used in various editing sites other than on-air systems used in television broadcasting stations.

1. An editing device for executing an editing process based on a list specifying edit details and registering an obtained editing result in an external device, comprising:
processing means for performing a prescribed process on edit material;
registration means for registering the editing result in the external device; and
control means for controlling said processing means and said registration means, wherein
said control means controls said processing means so as to perform the procession only necessary parts out of the edit material and controls said registration means so as to register only a result of the process of the necessary parts in the external device as the editing result.

2. The editing device according to claim 1, wherein
said control means controls said processing means so as to perform the process on only necessary parts out of the edit material based on the list and controls said registration means so as to register only a result of the process of the necessary parts as the editing result in the external device when the list being created is reproduced according to external operation in a creation mode of the list.

3. The editing device according to claim 2, wherein,
when a registration request of the editing result based on the list entered by external operation is given after the list is finished, said control means controls said processing means so as to perform the process on only necessary parts of which a result of the process has not been registered in the external device, out of the necessary parts out of the edit material, and controls said registration means so as to register a result of the process of the necessary parts in the external device as the editing result.

4. An editing method of executing an editing process based on a list specifying edit details and registering an obtained editing result in an external device, comprising:
a first step of performing a process on only necessary parts out of the edit material based on the list; and
a second step of registering only a result of the process of the necessary parts as the editing result in the external device.

5. The editing method according to claim 4, wherein
the first and second steps are executed when the list being created is reproduced according to external operation in a creation mode of the list.

6. The editing method according to claim 5, further comprising:
a third step of performing the process on only necessary parts of which a result of the process has not been registered in the external device, out of the necessary parts out of the edit material, when a registration request of the editing result based on the list entered by external operation is given after the list is finished; and
a fourth step of registering a result of the process of the necessary parts in the external device as the editing result.
